(19) United States
(12) Patent Application Publication
(10) Pub. No.: US 2016/0240092 A1
(43) Pub. Date: Aug. 18, 2016

(54) STUDY SYSTEM AND DISPLAY METHOD

(71) Applicant: SONY CORPORATION, Tokyo (JP)

(72) Inventors: Takefumi Hayashi, Tokyo (JP); Koji Nakanishi, Kanagawa (JP); Hideki Oshida, Kanagawa (JP); Hiroshi Kagawa, Kanagawa (JP); Takeshi Sasaki, Tokyo (JP); Hiroaki Nagaoka, Kanagawa (JP); Hideki Hagiwara, Tokyo (JP); Tetsuo Kato, Kanagawa (JP); Keiichi Fukushima, Tokyo (JP)

(21) Appl. No.: 14/977,608

(22) Filed: Dec. 21, 2015

Related U.S. Application Data
(63) Continuation of application No. 13/991,732, filed on Jun. 5, 2013.

(30) Foreign Application Priority Data
Dec. 13, 2010 (JP) 2010-276631

(51) Int. Cl. G09B 5/02; G06F 3/0483; G09B 7/00

(52) U.S. Cl. CPC G09B 5/02; G09B 7/00; G06F 3/0483

(57) ABSTRACT

A system is provided for displaying data. The system comprises a managing device. The managing device is configured to receive user input specifying lesson data. The managing device is further configured to transmit a display command to display teaching data corresponding to the lesson data, the display command including the lesson data. The system further comprises a plurality of study devices. The study devices comprise a receiving component configured to receive, from the managing device, the display command. The study devices further comprise a teaching component configured to display, in response to the display command, the teaching data on a teaching screen. The study devices still further comprise a notebook component. The notebook component is configured to receive notebook data. The notebook component is further configured to display, on a notebook screen, the notebook data.

### TECHNICAL FIELD

The present disclosure relates to a study system and a display method.

### BACKGROUND ART

In recent times, books have become available in other forms and electronic books have rapidly become widespread. Content provided in the form of electronic books is mainly literary works. Accordingly, many electronic book terminals that are becoming popular in the same way are dedicated to a “read” function, with other functions being extremely limited.

Meanwhile, a distance learning system has been proposed where a school-side server and a client (i.e., student)-side personal terminal exchange various data relating to the content of lectures via the Internet to enable each student to study from home using his/her personal terminal (see Japanese Laid-Open Patent Publication No. 2003-141267).

As content, such as technical books and study materials, used by educational institutions becomes available like literary works in electronic book format, it is thought that electronic book terminals will come into use for distance learning and other forms of study.

### CITATION LIST

### Patent Literature

PTL 1: JP 2003-141267A

### SUMMARY

### Technical Problem

If, as mentioned above, study materials are to be provided as electronic books and electronic book terminals are to be used for studying, it would be preferable to implement a data input function, such as a handwriting input function, to enable students to take notes during lessons.

Another conceivable way of using electronic book terminals for studying would be to have every student use one during a lesson in a classroom. In such case, in order for the lesson to proceed smoothly, it would be preferable to provide a function that enables the terminals to be controlled by the teacher.

However, since existing electronic book terminals are dedicated to the read function as described above, there is the problem that such terminals are not sufficiently equipped with the functions required for use during studying, which prevents students from studying efficiently.

The present disclosure aims to provide a novel and improved study system that enables students to study efficiently.

### Solution to Problem

Accordingly, there is provided an apparatus for transmitting a command, comprising a memory and a processor executing instructions stored in the memory. The processor executes instructions stored in the memory to receive user input specifying lesson data. The processor further executes instructions stored in the memory to transmit, to a plurality of study devices, a command to display teaching data corresponding to the lesson data, the display command including the lesson data.

In a second aspect, there is provided an apparatus for displaying data. The apparatus comprises a receiving component configured to receive, from a managing device, a display command including lesson data. The apparatus further comprises a teaching component comprising a teaching memory and a teaching processor executing instructions stored in the teaching memory to display, in response to the display command, teaching data on a teaching screen, the teaching data corresponding to the lesson data. The apparatus still further comprises a notebook component comprising a notebook memory and a notebook processor executing instructions stored in the notebook memory. The notebook processor executes instructions stored in the notebook memory to receive notebook data. The notebook processor further executes instructions stored in the notebook memory to display, on a notebook screen, the notebook data.

In a third aspect, there is provided a system for displaying data. The system comprises a managing device. The managing device is configured to receive user input specifying lesson data. The managing device is further configured to transmit a display command to display teaching data corresponding to the lesson data, the display command including the lesson data. The system further comprises a plurality of study devices. The study devices comprise a receiving component configured to receive, from the managing device, the display command. The study devices further comprise a teaching component configured to display, in response to the display command, the teaching data on a teaching screen. The study devices still further comprise a notebook component. The notebook component is configured to receive notebook data. The notebook component is further configured to display, on a notebook screen, the notebook data.

In a fourth aspect, there is provided a method of transmitting a command. The method comprises receiving user input specifying lesson data. The method further comprises transmitting, to a plurality of study devices, a command to display teaching data corresponding to the lesson data, the display command including the lesson data.

In a fifth aspect, there is provided a method of displaying data. The method comprises receiving, from a managing device, a display command including lesson data. The method further comprises displaying, in response to the display command, teaching data on a teaching screen, the teaching data corresponding to the lesson data. The method still further comprises receiving notebook data and displaying, on a notebook screen, the notebook data.

### Advantageous Effects of Invention

According to the embodiments of the present disclosure described above, it is possible to study efficiently.

### BRIEF DESCRIPTION OF DRAWINGS

FIG. 1 is an overall view of a study system that is common to respective embodiments of the present disclosure.

FIG. 2 is a block diagram showing the fundamental configuration of a study terminal that is common to the respective embodiments of the present disclosure.

FIG. 3 is a diagram useful in explaining an example display of a touch panel provided in a study terminal that is common to the respective embodiments of the present disclosure.

FIG. 4 is a diagram useful in explaining notebook data that is common to respective embodiments of the present disclosure.

FIG. 5 is a diagram useful in explaining an example where a text terminal and a notebook terminal that construct a study terminal that is common to the respective embodiments of the present disclosure are detachable.

FIG. 6 is a block diagram showing the fundamental configuration of a terminal managing apparatus that is common to the respective embodiments of the present disclosure.

FIG. 7 is a diagram useful in explaining an example usage of the terminal managing apparatus that is common to the respective embodiments of the present disclosure.

FIG. 8 is a diagram useful in explaining databases provided in a server that is common to the respective embodiments of the present disclosure.

FIG. 9 is a diagram useful in explaining link information that is common to the respective embodiments of the present disclosure.

FIG. 10 is a flowchart showing an operation process for having teaching material data and notebook data displayed according to a first embodiment of the present disclosure.

FIG. 11 is a flowchart useful in explaining a bookmark function according to a second embodiment of the present disclosure.

FIG. 12 is a diagram showing an example operation of the book marlfunction according to the second embodiment of the present disclosure.

FIG. 13 is a flowchart useful in explaining the bookmark function according to the second embodiment of the present disclosure.

FIG. 14 is a diagram showing an example operation of the bookmark function according to the second embodiment of the present disclosure.

FIG. 15 is a diagram useful in explaining a copy function according to a third embodiment of the present disclosure.

FIG. 16 is a flowchart showing a monitoring process for updating of notebook data according to a fourth embodiment of the present disclosure.

FIG. 17 is a flowchart showing a correction process according to a fifth embodiment of the present disclosure.

FIG. 18 is a diagram useful in explaining one example of a correction process according to the fifth embodiment of the present disclosure.

FIG. 19 is a flowchart showing a coordinated operation process according to a sixth embodiment of the present disclosure.

FIG. 20 is a flowchart showing a material data distribution process according to a seventh embodiment of the present disclosure.

FIG. 21 is a flowchart showing a groupwork process using notebook data for a shared notebook according to an eighth embodiment of the present disclosure;

FIG. 22 is a flowchart showing a groupwork process using notebook data for a shared notebook according to the eighth embodiment of the present disclosure.

FIG. 23 is a flowchart showing an operation process at the end of a lesson according to a ninth embodiment of the present disclosure.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The following description is given in the order indicated below.

1. Basic Configuration of Study System that is Common to the Embodiments of the Present Disclosure

2. First Embodiment (Displaying of Teaching Material Data and Notebook Data)

3. Second Embodiment (Bookmark Function)

4. Third Embodiment (Data Copy Function)

5. Fourth Embodiment (Monitoring Process for Updating of Notebook Data)

6. Fifth Embodiment (Correction Process)

7. Sixth Embodiment (Coordinated Operation Process)

8. Seventh Embodiment (Distribution Process for Material Data)

9. Eighth Embodiment (Groupwork)

10. Ninth Embodiment (Operation Process at Lesson End)

11. Conclusion

### 1. Basic Configuration of Stud System that is Common to the Embodiments of the Present Disclosure

The present disclosure can be implemented in a variety of forms, with detailed examples being described below under the “2. First Embodiment” to “10. Ninth Embodiment” headings. The study systems described in the respective embodiments each include:

A: a terminal managing apparatus (30) transmitting a display command showing teaching material data to be displayed on a plurality of study terminal apparatuses; and

B: a plurality of study terminal apparatuses (study terminals 10) each including a teaching material region displaying the teaching material data shown by the display command and a notebook region capable of inputting data and displaying data.

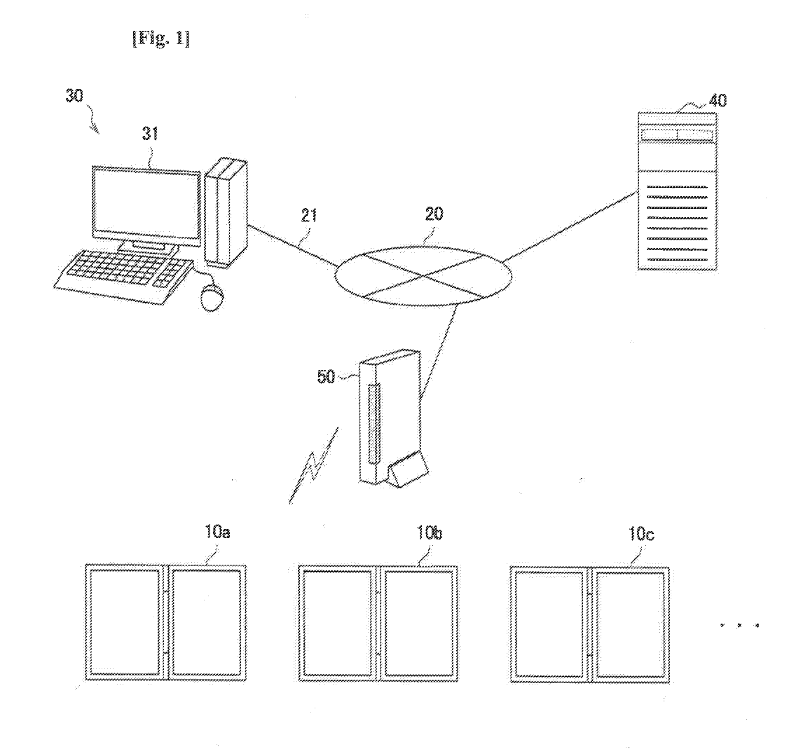

First, the basic configuration that is common to the respective embodiments will be described below with reference to FIGS. 1 to 9.

1-1. Overview of Study System

First, an overview of a study system according to embodiments of the present disclosure will be described with reference to FIG. 1. As shown in FIG. 1, the study system includes a plurality of study terminals 10 (10a, 10b, 10c, (i.e., study devices), a terminal managing apparatus 30 (i.e., a managing device), and a server 40 (i.e., a learning material resource) that are connected via a network 20. Note that the terminal managing apparatus 30, the server 40, and an access point 50 (i.e., a receiving component) may be connected by a LAN. Also, in the example shown in FIG. 1, the study terminals 10 are connected to the network 20 via wireless communication (for example, Wi-Fi (Wireless Fidelity)) with the access point 50.

When such study system is adapted to lessons in a classroom, it is possible for the teacher to manage the study terminals 10 used by the respective students from the terminal managing apparatus 30. As examples, it is possible to cause the study terminals 10 to display textbook data (i.e., teaching data) indicated by the term managing apparatus 30 and to monitor notebook data that has been written by the respective students on the study terminals 10 using the terminal managing apparatus 30. Also, textbook data and notebook data are stored in the server 40. The basic configuration of the study terminals 10, the terminal managing apparatus 30, and the server 40 that construct the study system will now be described with reference to the drawings.

1-2. Study Terminal

Configuration

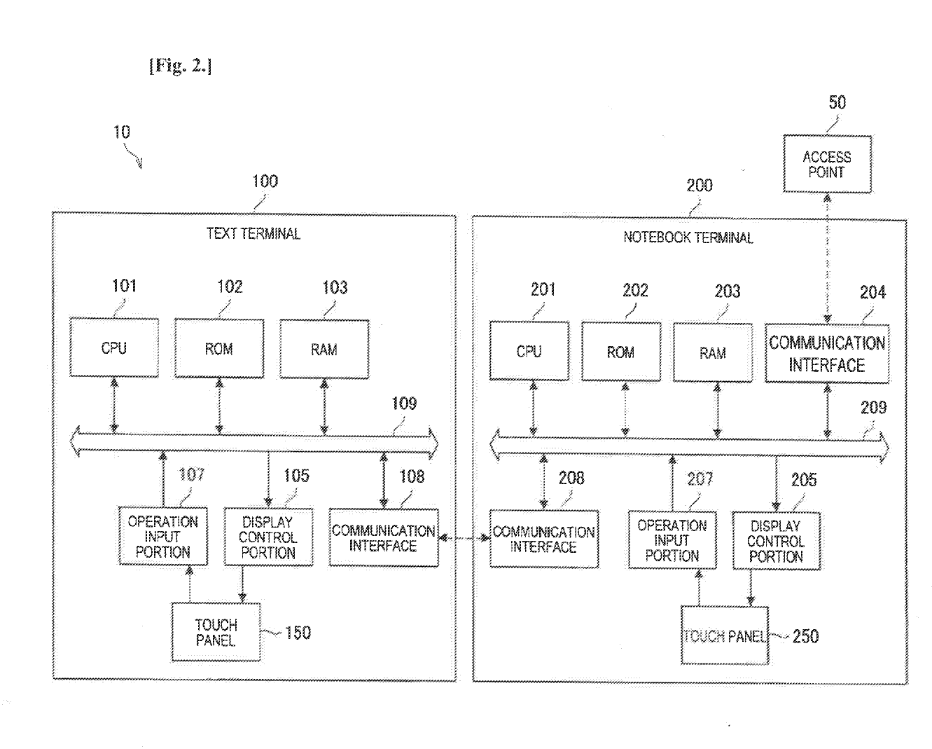

First, the basic configuration of the study terminals 10 will be described with reference to FIG. 2. As shown in FIG. 2, each study terminal 10 is composed of a text terminal 100 (i.e., a teaching component) and a notebook terminal 200 (i.e., a notebook component). The text terminal 100 includes a CPU (Central Processing Unit) 101, a ROM (Read Only Memory) 102, a RAM (Random Access Memory) 103, a display control portion 105, an operation input portion 107, and a communication interface 108. Here, the ROM 102 stores programs, computational parameters, and the like used by the CPU 101. The RAM 103 temporarily stores a program in use during execution by the CPU 101, parameters that change as appropriate during such execution, and the like. The CPU 101 controls the entire text terminal 100 using the ROM 102 and the RAM 103. Such elements are connected to one another by a host bus composed of a CPU bus or the like.

The display control portion 105 generates image data to be displayed on a touch panel 150 (i.e., a teaching screen) and carries out control to have such data displayed on the touch panel 150. The touch panel 150 is a capacitive touch panel, for example, and detects a position on a display screen that has been touched by a finger as an operation body. The operation input portion 107 receives an operation input based on position information inputted from the touch panel 150.

Meanwhile, the notebook terminal 200 includes a CPU (Central Processing Unit) 201, a ROM (Read Only Memory) 202, a RAM (Random Access Memory) 203, a communication interface 204, a display control portion 205, an operation input portion 207, and a communication interface 208. Here, the ROM 202 stores programs, computational parameters, and the like used by the CPU 201. The RAM 203 temporarily stores a program in use during execution by the CPU 201, parameters that change as appropriate during such execution, and the like. The CPU 201 controls the entire notebook terminal 200 using the ROM 202 and the RAM 203. Such elements are connected to one another by a host bus 209 composed of a CPU bus or the like.

The display control portion 205 generates image data to be displayed on a touch panel 250 (i.e., a notebook screen) and carries out control to have such data displayed on the touch panel). The touch panel 250 is a capacitive touch panel, for example, and detects a position on a display screen that has been touched by a finger as an operation body. The operation input portion 207 receives an operation input based on position information inputted from the touch panel 250.

The communication interface 204 of the notebook terminal 200 carries out wireless communication with the access point 50 (for example, communication according to WiFi) to transmit and receive data to and from the terminal managing apparatus 30 and the server 40 via the network 20 shown in FIG. 1. The communication interface 208 of the notebook terminal 200 also carries out communication (for example, communication using a LAN) with the communication interface 108 of the text terminal 100 to transmit and receive data. By doing so, the text terminal 100 shown in FIG. 2 becomes capable of transmitting and receiving data to and from another apparatus via the notebook terminal 200. Note that the text terminal 100 and the notebook terminal 200 according to the present embodiment are not limited to the configuration shown in FIG. 2. For example, the text terminal 100 may include a communication interface that is capable of communicating with the access point 50.

Example Usage

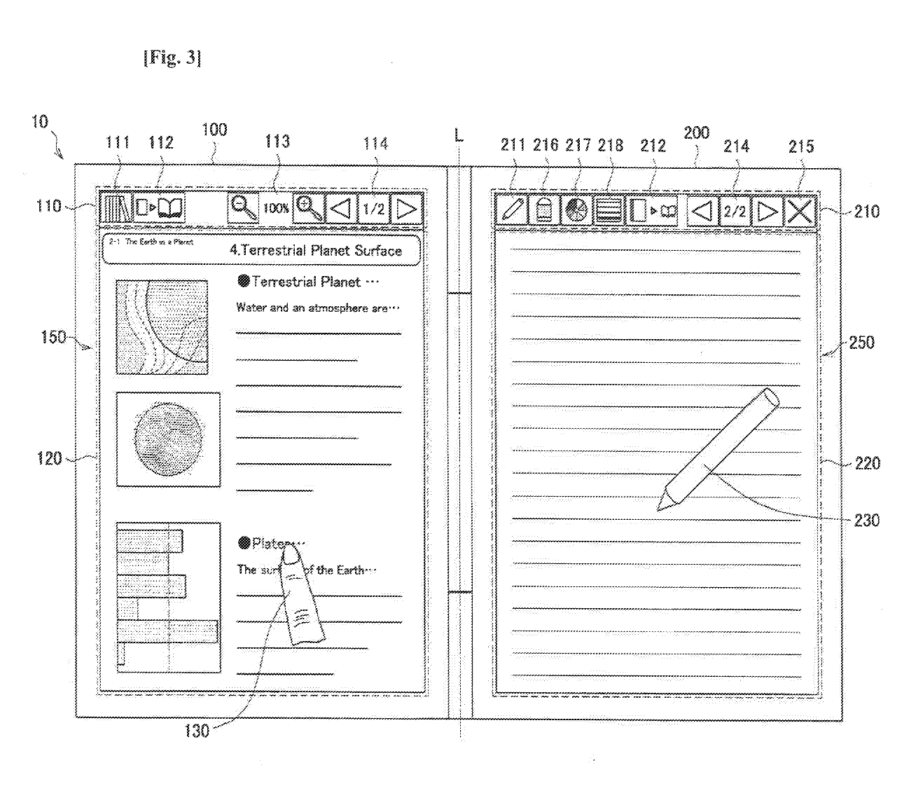

Next, an example usage of the study terminal 10 will be described with reference to 3. As shown in 3, the text terminal 100 and the notebook terminal 200 that construct the study terminal 10 are connected so as to be capable of being opened and closed about a center axis L. Accordingly, during use, the study terminal 10 is opened about the center axis L and is placed in a state where the display screens are visible as shown in FIG. 3.

Next, the display content will be described. The touch panel 150 of the text terminal 100 includes a teaching material region that displays teaching material data 120 such as textbook data and a study workbook. A menu bar 110 showing operation icons may also be displayed.

For example, as shown in FIG. 3, operation icons 111 to 114 are displayed on the menu bar 110. The operation icon 111 is an icon for selecting the teaching material data to be displayed. For example, when the operation icon 111 is touched by the finger 130, a list of teaching material data that is capable of being displayed on the touch panel 150 is displayed so that desired teaching material data can be selected. In FIG. 3, textbook data is displayed as one example of teaching material data.

The operation icon 112 is an icon that is operated when a bookmark function is used. More specifically, when the operation icon 112 is touched by the finger 130, notebook data that is linked to the teaching material data presently on display on the touch panel 150 is displayed on the touch panel 250 of the notebook terminal 200. Such bookmark function will be described in detail in the “3. Second Embodiment” section.

The operation icon 113 is an icon for operations that enlarge and reduce the display of the touch panel 150. The operation icon 114 is an icon for operating the display page of the teaching material data.

Meanwhile, the notebook terminal 200 includes a notebook region that is capable of displaying notebook data and inputting data. A menu bar showing operation icons may also be displayed.

For example, as shown in FIG. 3, operation icons 211 to 215 are displayed on a menu bar 210. The operation icon 211 is an icon for carrying out handwritten input on the touch panel 250 using a pen 230. The operation icon 216 is an icon for carrying out deletion of written data. The operation icon 217 is an icon for selecting the color of handwritten input. The operation icon 218 is an icon for selecting the thickness of lines of handwritten input.

The operation icon 212 is an icon for operations when a bookmark function is used. More specifically, when the operation icon 212 is touched with the pen 230, the teaching material data linked to the notebook data presently on display on the touch panel 250 is displayed on the touch panel 150 of the text terminal 100. Such bookmark function will be described in detail in the “3. Second Embodiment” section.

The operation icon 214 is an icon for operating display pages of the notebook data. The operation icon 215 is an icon for ending the displaying of notebook data.

Layer Construction of Notebook Data

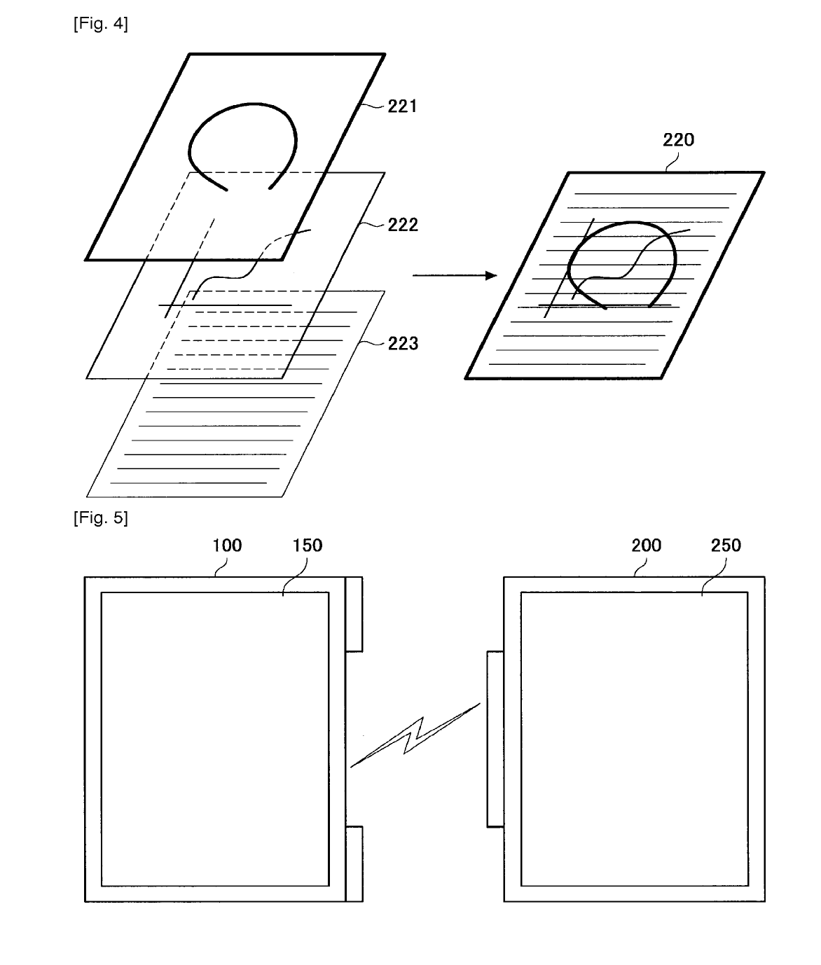

The layer construction of the notebook data 220 will now be described. As shown in FIG. 4, the notebook data 220 is composed of a plurality of layers made up of a layer 221 on which the teacher inputs data, a layer 222 on which the student inputs data, and a layer 223 on which data, such as ruled lines, has been inputted in advance. In addition, access restrictions may be set for each layer. For example, an access restriction is set for the layer 221 so that access is accepted from only the terminal managing apparatus 30 used by the teacher, an access restriction is set for the layer 222 so that access is accepted only from the study terminal 10 used by the student, and, since it is data for ruled lines, an access restriction is set for the layer 223 so that access is not received from either apparatus. The notebook data 220 composed of such plurality of layers 221 to 223 is displayed in a state where the layers are superimposed.

Other Embodiments of the Study Terminal 10

The study terminal 10 that is common to the respective embodiments is not limited to a configuration that is linked so as to be rotatable about the center axis L as shown in FIG. 3. For example, as shown in FIG. 5, a configuration where the text terminal 100 equipped with the touch panel 150 and the notebook terminal 200 equipped with the touch panel 250 are detachably linked may be used. In such case, data is transmitted and received between both terminals using wireless communication. By using a detachable construction for the study terminal 10, it is possible for the student to study with the text terminal 100 and the notebook terminal 200 in positions and orientations that facilitate use.

1-3. Terminal Managing Apparatus

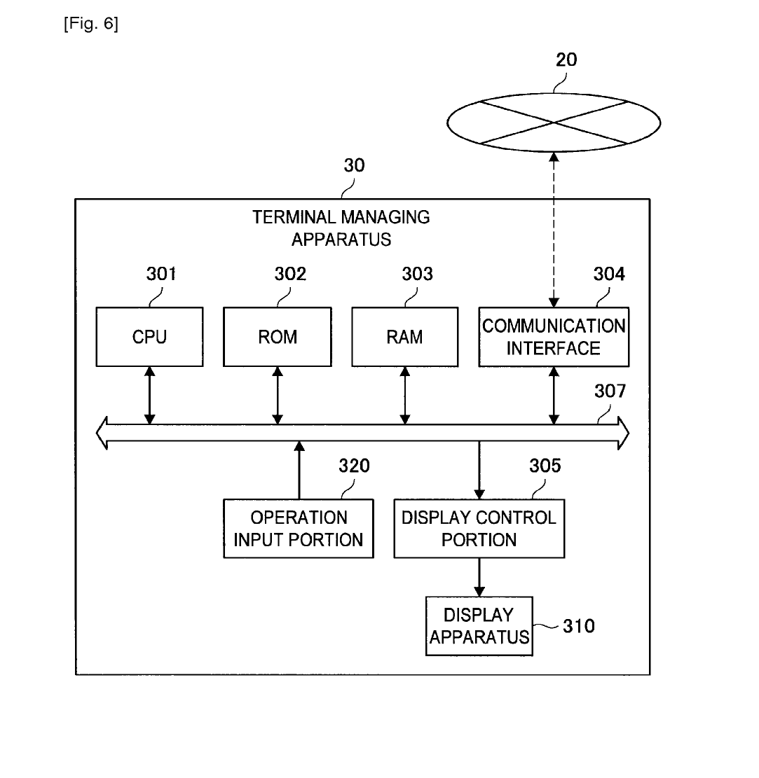

Next, the basic configuration of the terminal managing apparatus 30 that is common to the various embodiments will be described with reference to FIG. 6. As shown in FIG. 6, the terminal managing apparatus 30 includes a CPU 301, a ROM 302, a RAM 303, a communication interface 304, a display control portion 305, and an operation input portion 320. Here, the ROM 302 stores programs, computational parameters, and the like used by the CPU 301. The RAM 303 temporarily stores a program in use during execution by the CPU 301, parameters that change as appropriate during such execution, and the like. The CPU 301 controls the entire terminal managing apparatus 30 using the ROM 302 and the RAM 303. Such elements are connected to one another by a host bus 307 constructed of a CPU bus or the like.

The display control portion 305 generates image data to be displayed on a display apparatus 310 and carries out control to have such data displayed on the display apparatus 310. The operation input portion 320 receives a key input and the like made by a keyboard 321 or a mouse 322, described later.

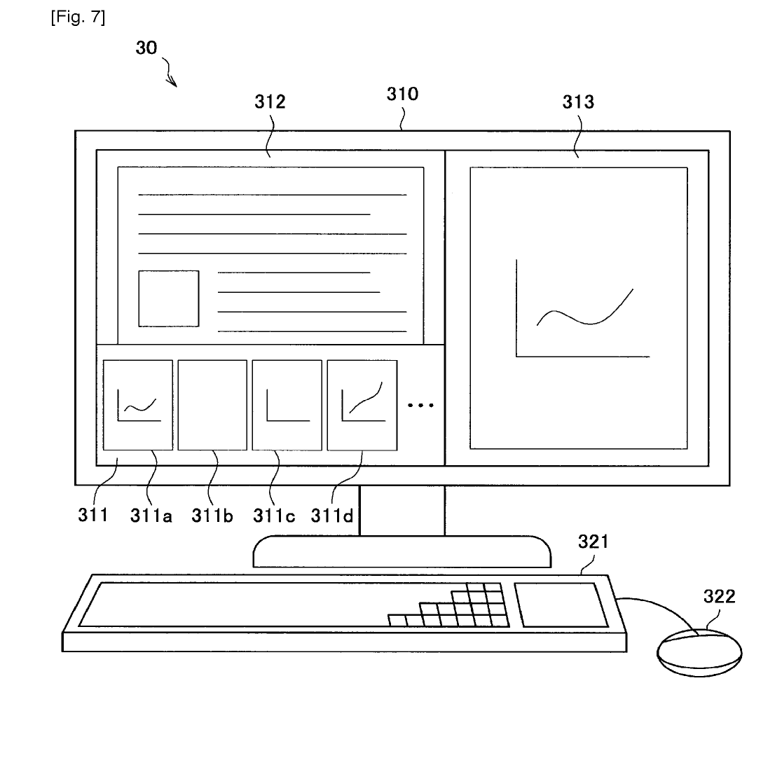

Next, the composition of the screens displayed on the display apparatus 310 will he described with reference to FIG. 7. As shown in FIG. 7, the display screen of the display apparatus 310 is composed of a list region 311 that displays a list of notebook data (311a, 311b, 311c, . . . ) displayed on the touch panels 250 of the respective study terminals 10, a text region 312 in which teaching material data is displayed, and a display region 313 displaying one notebook data selected out of the notebook data displayed in the list region 311. In FIG. 7, as one example, the notebook data 311a is selected and displayed in the display region 313.

Note that although the terminal managing apparatus 30 (a desktop personal computer) is given in the present specification as one example of a terminal managing apparatus, the terminal managing apparatus for the present disclosure is not limited to this example. For example, the terminal managing apparatus may be an apparatus (teacher console) that has been integrated into the desk used by the teacher in the classroom.

1-4. Server

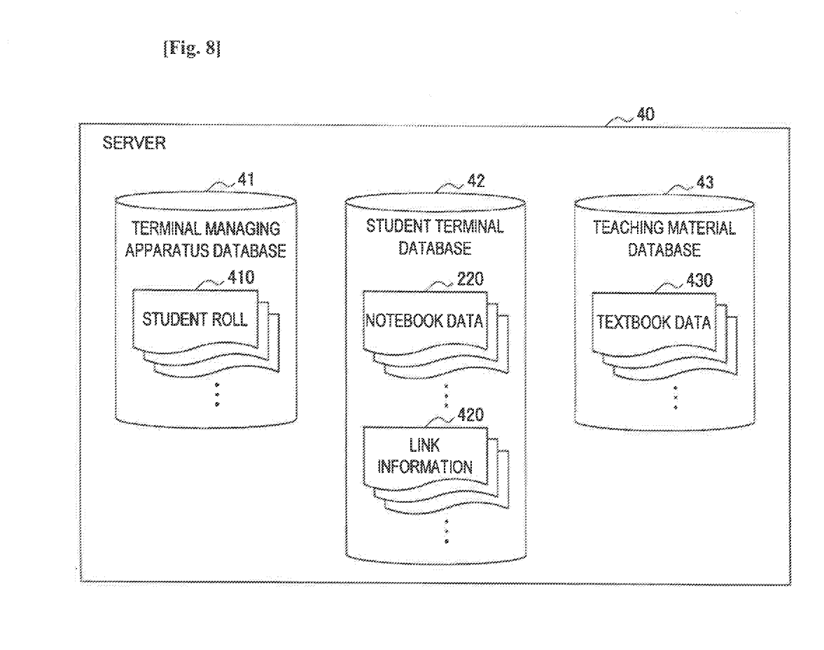

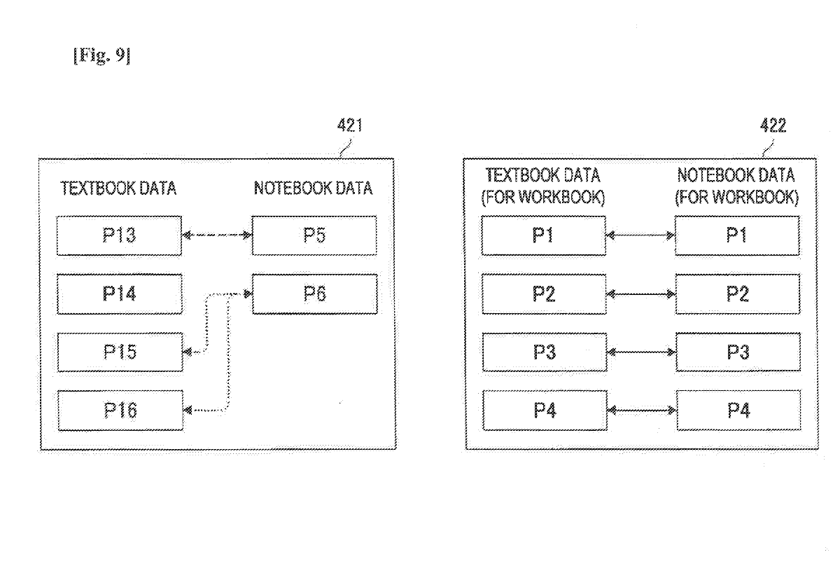

Next, the databases provided in the server 40 will be described with reference to FIG. 8. As shown in FIG. 8, the server 40 includes a terminal managing apparatus database 41, a student terminal database 42, and a teaching material database 43.

Aside from a student roll 410 shown in FIG. 8, the terminal managing apparatus database 41 stores data used by the teacher on the terminal managing apparatus 30, such as curriculum data relating to a plan of lessons, data on student grades, and the like.

The student terminal database 42 stores the notebook data 220 of each student, and link information 420 for each student. The link information 420 is described in detail later.

Aside from the textbook data 430 shown in FIG. 8, the teaching material database 43 stores teaching material data, such as material data. Here, aside from a textbook in text format, the expression “teaching material data” may be in the form of questions, such as a workbook.

Link Information 420

The link information 420 stored in the student terminal database 42 mentioned above will now be described with reference to FIG. 9. On the left side of FIG. 9, one example (link information 421) of the link information 420 generated as two-way bookmarks between the textbook data and notebook data is shown.

As shown by the link information 421 in FIG. 9, when, during a lesson, data input is carried out for the notebook data P5 at the notebook terminal 200 of the study terminal 10 while the textbook data P13 is being displayed on the text terminal 100 of the study terminal 10, the textbook data P13 and the notebook data P5 are linked.

Also, when data input into the notebook data P6 displayed on the notebook terminal 200 of the study terminal 10 starts while the textbook data P15 is being displayed on the text terminal 100 of the study terminal 10 and data input into the notebook data P6 continues after the textbook data P16 has then been displayed on the text terminal 100, the textbook data P15 and P16 are linked with the notebook data P6 (see the link information 421 in FIG. 9).

When notebook data has been newly generated at the study terminal 10, the link information 420 is updated by the study terminal 10 transmitting the generated notebook data and also information (textbook name and/or page number) showing the textbook data that was being displayed by the text terminal 100 during input of the notebook data to the server 40.

On the right side of FIG. 9, one example (link information 422) of the link information 420 generated as two-way bookmarks between textbook data as a workbook and notebook data is shown. With a workbook, it is possible to link text in advance with a corresponding practice notebook, a set of answers for a question page, or the like. Accordingly, like the link information 422 shown in FIG. 9 for example, the linking of textbook data for a workbook with notebook data is carried out in advance. By doing so, when the bookmark function described later in the second embodiment is used, it is possible to change the page of the notebook in coordination with a change in the page of the textbook on the study terminal 10 and also to change the page of a textbook in coordination with a change in the page of the notebook.

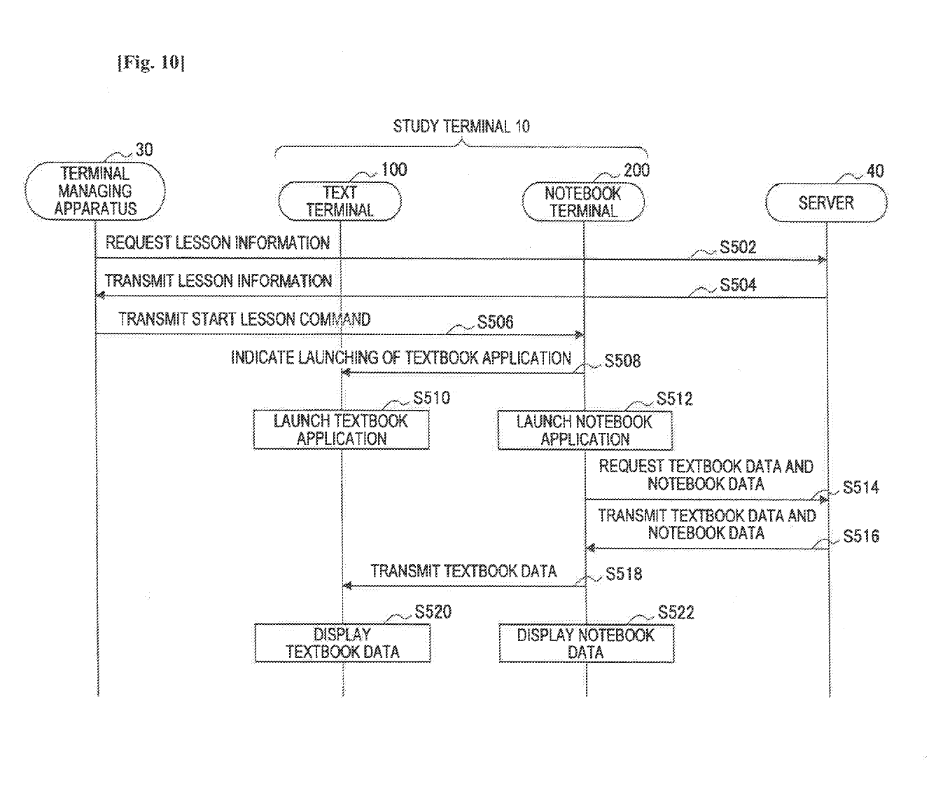

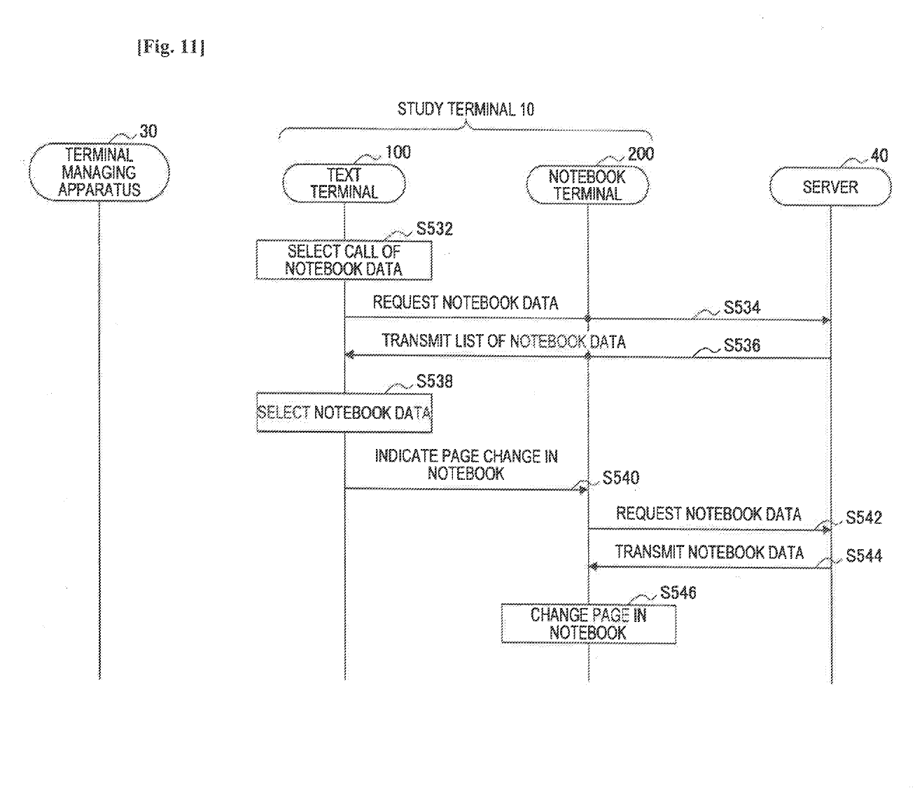

This completes the description of the basic configuration that is common to the embodiments of the present disclosure. Next, the respective embodiments from the “2. First Embodiment” to the “10. Ninth Embodiment” of the present disclosure will be described with reference to FIGS. 10 to 23.

### 2. First Embodiment

### Displaying of Teaching Material and Notebook Data

First, as a first embodiment, the operation process at the start of a lesson will be described with reference to the flowchart shown in FIG. 10.

First, at the start of a lesson, a request for lesson information is sent from the terminal managing apparatus 30 to the server 40 (S502). Next, the server 40 transmits lesson information in response to the request from the terminal managing apparatus 30 (S504). Here, the lesson information includes data that is required for the lesson to proceed, such as curriculum data, a student roll, a list of courses, and textbook data.

Next, a start lesson command (i.e., a display command) is transmitted from the terminal managing apparatus 30 to the notebook terminal 200 that constructs each study terminal 10 (S506). The start lesson command includes a course, a textbook name, and a designated page (i.e., lesson data).

After this, the notebook terminal 200 that has received the start lesson command instructs the text terminal 100 to launch a textbook application (S510). The text terminal 100 that has received the launch textbook application instruction from the notebook terminal 200 launches the textbook application (S510).

Next, the notebook terminal 200 requests the server 40 to transmit the textbook data corresponding to the textbook name and designated page included in the start lesson command received from the terminal managing apparatus 30 and also the notebook data (S514). The notebook data may be notebook data corresponding to the course included in the start lesson command or may be notebook data that is linked to the designated page of the textbook name included in the start lesson command. Note that since notebook data for each student is stored in the server 40, the notebook terminal 200 may send a request that includes an ID capable of identifying the student to the server 40.

After this, the server 40 transmits the textbook data and the notebook data in response to the request from the notebook terminal 200 (S516).

The textbook data transmitted from the server 40 is transmitted from the notebook terminal 200 to the text terminal 100 (S518).

Next, the text terminal 100 displays the textbook data obtained from the server 40 via the notebook terminal 200 on the touch panel 150 (S520).

After this, the notebook terminal 200 displays the notebook data acquired from the server 40 on the touch panel 250 (S522).

According to the first embodiment described above, at the start of a lesson, by having the teacher designate a specified page of a specified textbook using the display device 300, it is possible to display such specified page of the specified textbook on the textbook region of the study terminal 10 used by each student. In this way, by managing the respective study terminals 10 using the terminal managing apparatus 30, it is possible to start a lesson efficiently.

### 3. Second Embodiment

### Bookmark Function

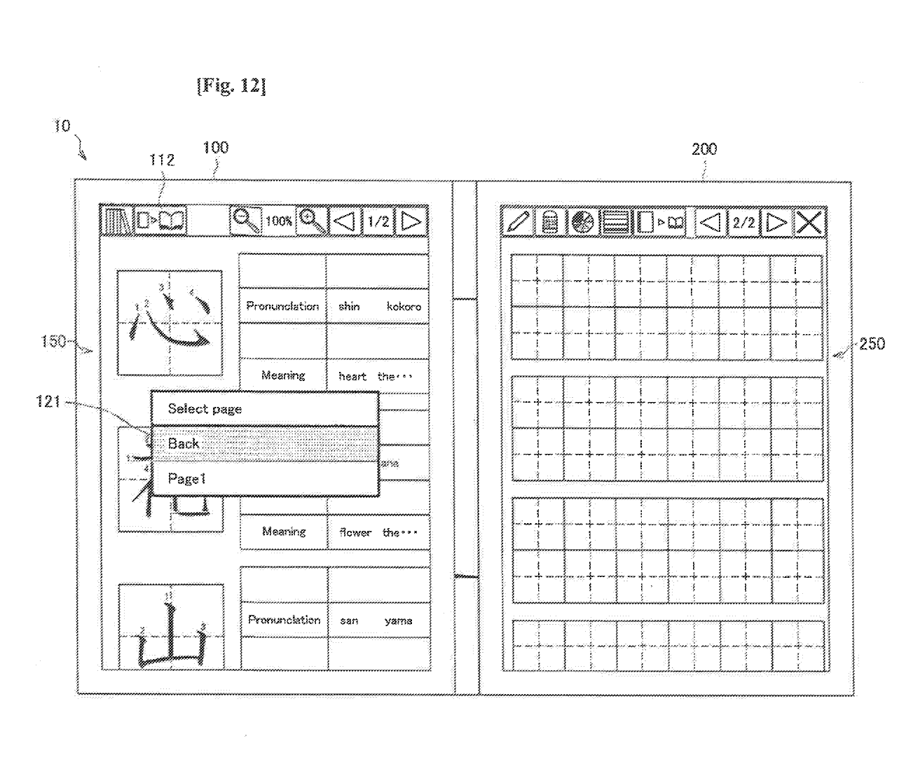

Next, as a second embodiment, a bookmark function will be described with reference to FIGS. 11 and 12.

First, the operation icon 112 displayed on the text terminal 100 (see FIG. 12) is touched to select a call of notebook data (S532).

After this, the text terminal 100 sends a request for the notebook data via the notebook terminal 200 to the server 40 (S534). When doing so, the text terminal 100 transmits information showing the textbook name and page number of the textbook data displayed on the text terminal 100 to the server 40.

Next, the server 40 refers to the link information 420 stored in the student terminal database 42 and searches for notebook data linked to the page number of the textbook name transmitted from the text terminal 100. If, as a result, a plurality of notebook data are linked to a single page of the textbook data, the server 40 transmits a list of notebook data to the text terminal 100 (S536).

After this, the text terminal 100 that has received a list of notebook data from the server 40 makes a display requesting the student to select notebook data. As one example, as shown in FIG. 12, a selection display 121 is shown on the touch panel 150 of the text terminal 100. A list of notebook data linked to the textbook data presently on display is displayed in the selection display 121. For example, pages that are linked to the page of textbook data on display at present on the touch panel 150 of the text terminal 100 may be displayed using page numbers such as “Page 1”. Note that to end the menu for calling the notebook data, “Back” on the selection display 121 is selected.

When the student has selected the notebook data (S538), the text terminal 100 instructs the notebook terminal 200 to change the page (S540). Next, the notebook terminal 200 sends a request to the server 40 for the notebook data selected by the student on the text terminal 100 (S542). After this, in response to the request from the notebook terminal 200, the server 40 transmits the notebook data in question from the notebook data 220 of the student terminal database 42 to the notebook terminal 200 (S544). The notebook terminal 200 then displays the notebook data transmitted from the server 40 on the touch panel 250 (S546).

Note that in step S536 described above, when a plurality of notebook data are linked to the textbook data, a list of notebook data is transmitted to the text terminal 100. However, the bookmark function according to the present embodiment is not limited to the operation process shown in FIG. 11. For example, when the notebook data linked to the textbook data is one page, the notebook data of such page may be transmitted from the server 40 to the notebook terminal 200 and displayed on the touch panel 250 of the notebook terminal 200. By doing so, the notebook data displayed on the notebook terminal 200 can be automatically changed by touching the operation icon 112 on the text terminal 100.

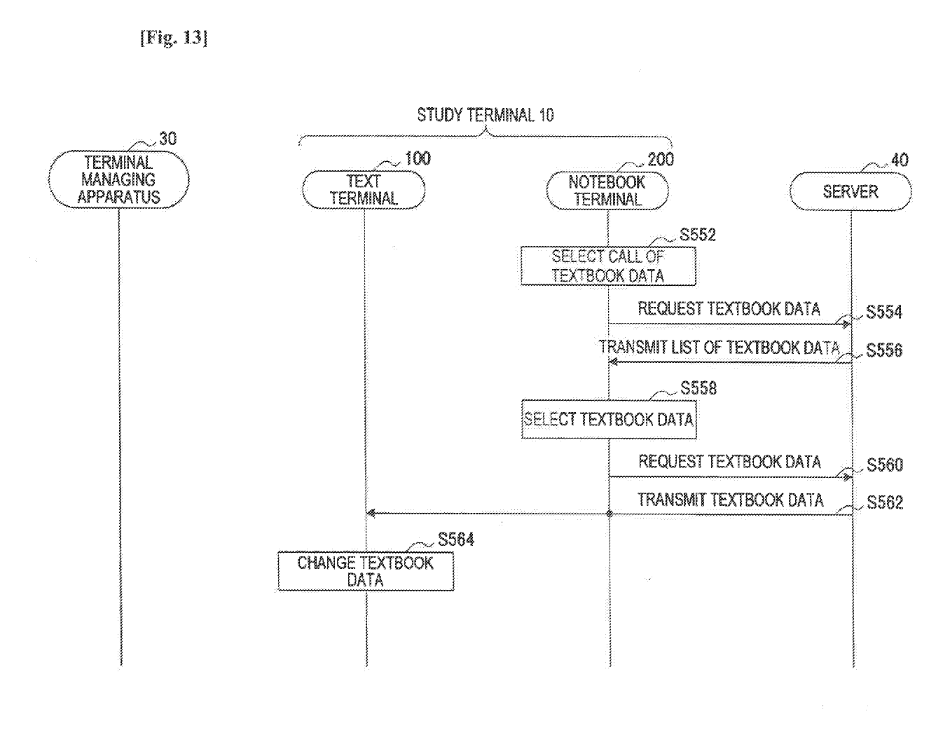

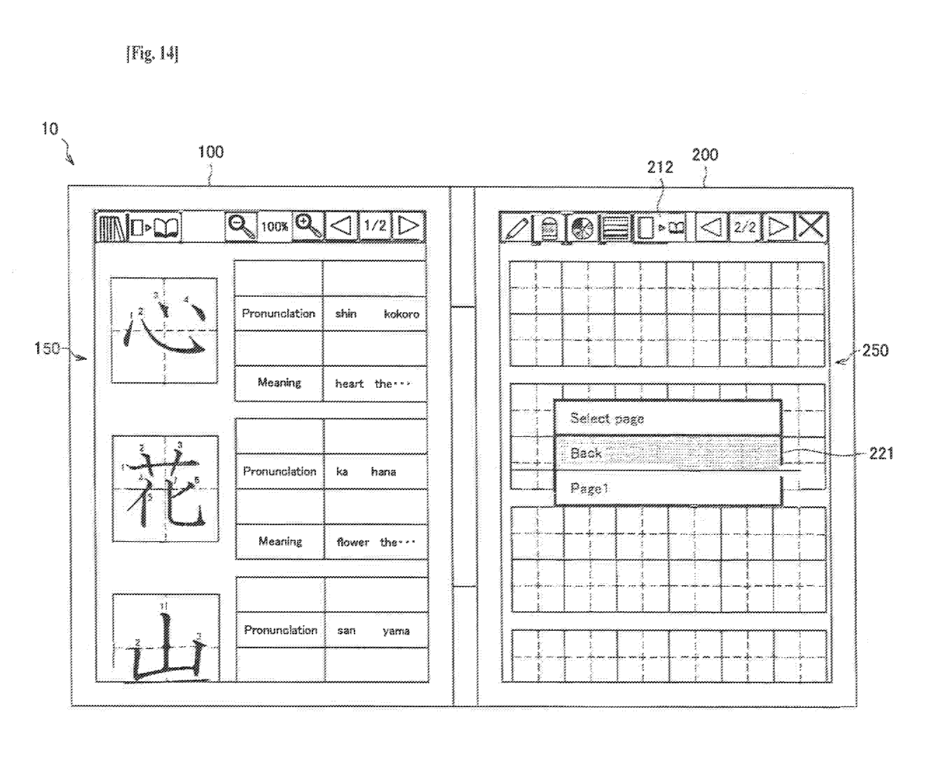

This completes the description of the bookmark function when a call of notebook data is selected on the text terminal 100. Meanwhile, when a call of textbook data has been selected on the notebook terminal 200, it is also possible to automatically update the display of textbook data on the text terminal 100 according to the bookmark function. The operation process of the bookmark function when a call of textbook data on the notebook terminal 200 has been selected will now be described with reference to FIGS. 13 and 14.

As shown in FIG. 13, first, the operation icon 212 displayed on the notebook terminal 200 is touched (see FIG. 14) to select a call of notebook data (S552).

Next, the notebook terminal 200 sends a request for the textbook data to the server 40 (S554). At this time, the notebook terminal 200 transmits information (for example, a page number) showing the notebook data being displayed on the notebook terminal 200 to the server 40.

After this, the server 40 refers to the link information 420 stored in the student terminal database 42 and searches for textbook data linked to the page number of the notebook data transmitted from the notebook terminal 200. If the search result finds that a plurality of textbook data are linked, the server 40 transmits a list of textbook data to the notebook terminal 200 (S556).

Next, the notebook terminal 200 that has received the list of textbook data from the server 40 makes a display requesting the student to select the textbook data. As one example, as shown in FIG. 14, a selection display 221 is shown on the touch panel 250 of the notebook terminal 200. A list of textbook data linked to the notebook data presently on display is displayed in the selection display 221. For example, the pages that are linked to the page of notebook data on display at present on the touch panel 250 of the notebook terminal 200 may be displayed using page numbers such as “Page 1”. Note that to end the menu for calling the textbook data, “Back” on the selection display 221 is selected.

When the student has selected the textbook data (S558), the notebook terminal 200 sends a request to the server 40 for the textbook data selected by the student (S560). After this, in response to the request from the notebook terminal 200, the server 40 transmits the textbook data in question from the textbook data 430 of the teaching material database 43 via the notebook terminal 200 to the text terminal 100 (S562). The text terminal 100 then changes the textbook data displayed on the touch panel 150 to the textbook data transmitted from the server 40 (S564).

Note that in step 5556 described above, when a plurality of textbook data are linked to the notebook data, a list of textbook data is transmitted to the notebook terminal 200. However, the bookmark function according to the present embodiment is not limited to the operation process shown in FIG. 13. For example, when the textbook data linked to the notebook data is one page, the textbook data of such page may be transmitted from the server 40 to the text terminal 100 and displayed on the touch panel 150 of the text terminal 100. By doing so, the textbook data displayed on the text terminal 100 can be automatically changed by touching the operation icon 212 on the notebook terminal 200.

According to the second embodiment described above, it is possible to display notebook data linked to the textbook data presently on display with a one-touch operation. It is also possible to display textbook data linked to the notebook data presently on display with a one-touch operation. By doing so, it is possible for the student to study efficiently using the study terminal 10.

### 4. Third Embodiment

### Data Copy Function

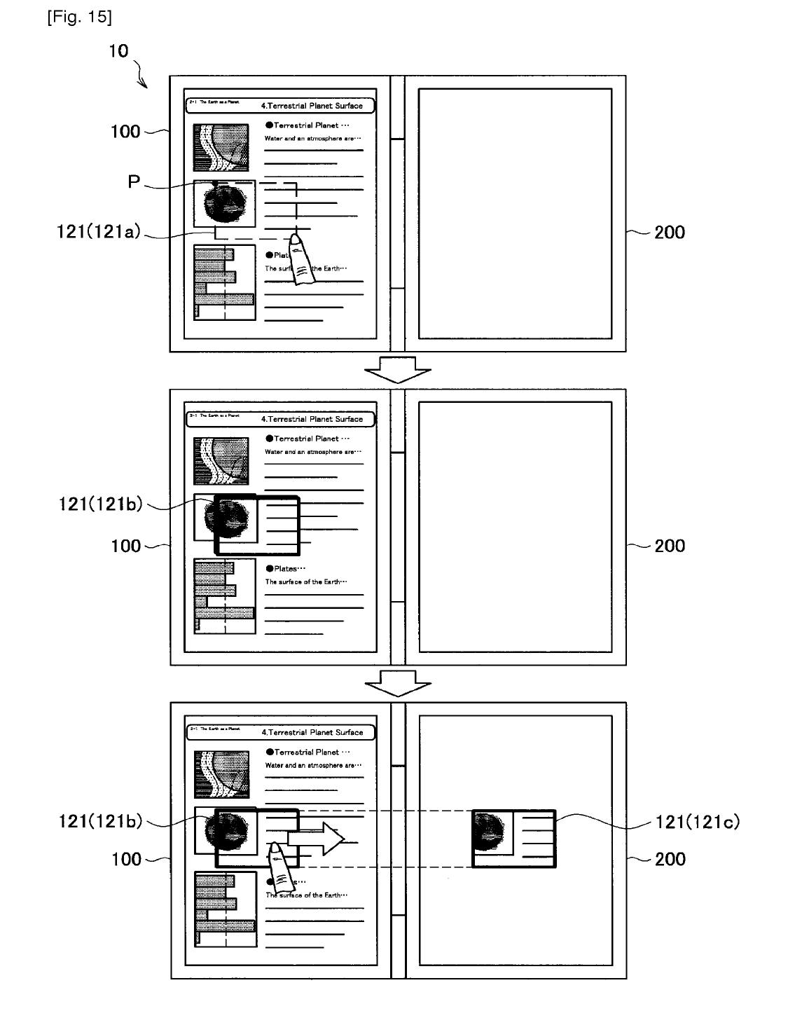

Next, as a third embodiment, a data copy function will be described with reference to FIG. 15. First, a region to be copied out of the textbook data displayed on the text terminal 100 is designated using the student's finger. For example, as shown in the drawing at the top of FIG. 15, a copy region 121 (121a) (i.e., a portion) is decided by dragging the finger from the point P. Note that although a rectangular copy region is decided in FIG. 15, an arbitrary region, such as a triangular, circular, or star-shaped region, may be selected.

After this, as shown by the drawing in the middle in FIG. 15, the finger that has been dragged is moved away when the copy region has been decided. By doing so, the copy region 121 is displayed in a floating state (copy region 121b).

Next, as shown by the drawing at the bottom in FIG. 15, by making an operation that throws (flips) the copy region 121 (121b) toward the notebook terminal 200, the copy region 121 (121c) is copied to the notebook terminal 200.

According to the third embodiment described above, by pasting a copy of the hook data together with a pen input when inputting data into the notebook data during study on the study terminal 10, it is possible for the student to study more efficiently.

### 5. Fourth Embodiment

### Monitoring Process for Updating of Notebook Data

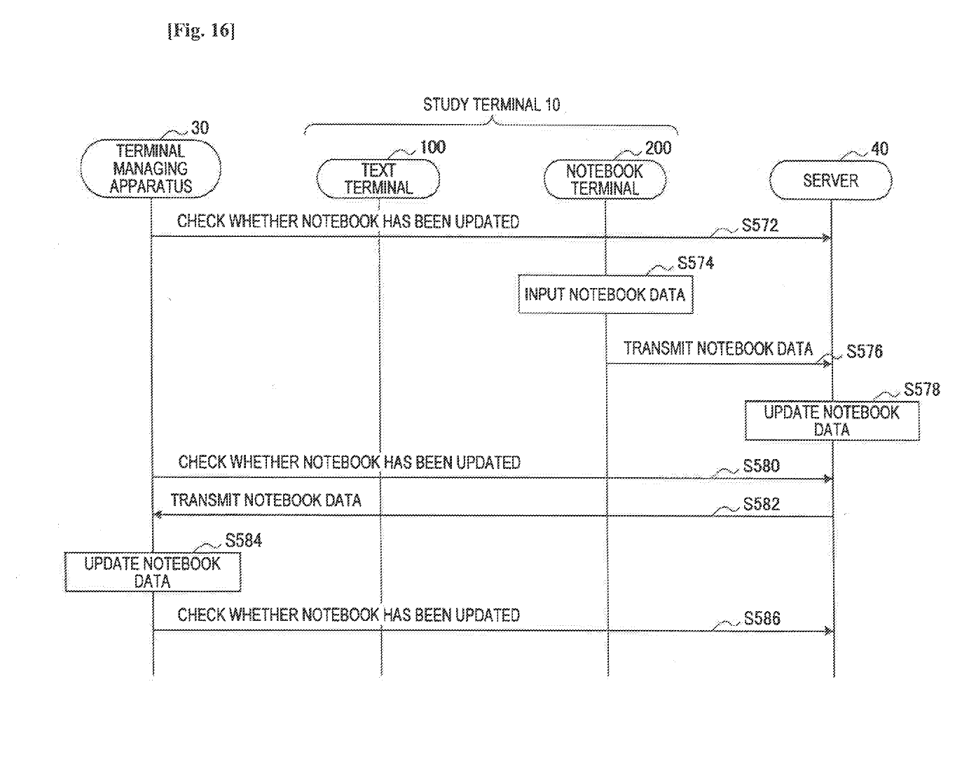

Next, a monitoring process for updating of the notebook data according to a fourth embodiment will be described with reference to FIG. 16. As shown in FIG. 16, the terminal managing apparatus 30 regularly enquires to the server 40 to check whether the notebook data has been updated (S572).

When the inputting of notebook data has been carried out by the student (S574), the notebook terminal 200 transmits the inputted notebook data to the server 40 (S576). After this, at the server 40, the notebook data 220 of the student terminal database 42 is updated (S578). Here, since the notebook data 220 is stored for each student, in S576, an ID that identifies the student may be transmitted from the notebook terminal 200 in S576 together with the notebook data.

Next, a regular enquiry to check whether the notebook data has been updated is made from the terminal managing apparatus 30 (S580). After this, if the notebook data has been updated, the server 40 transmits the updated notebook data to the terminal managing apparatus 30 (S582).

Next, at the terminal managing apparatus 30, the notebook data displayed in the list region 311 (see FIG. 7) for the respective study terminals 10 is updated (S584). Hereafter also, regular enquiries to check for updating of the notebook data are made from the terminal managing apparatus 30 to the server 40 (S586).

According to the fourth embodiment described above, it is possible to regularly update the states of the display screens for the notebook terminals 200 that construct the respective study terminals 10 and check such states at the terminal managing apparatus 30. By doing so, it is possible for the teacher to check what is written in the notebooks of the respective study terminals 10 in real time.

### 6. Fifth Embodiment

### Correction Process

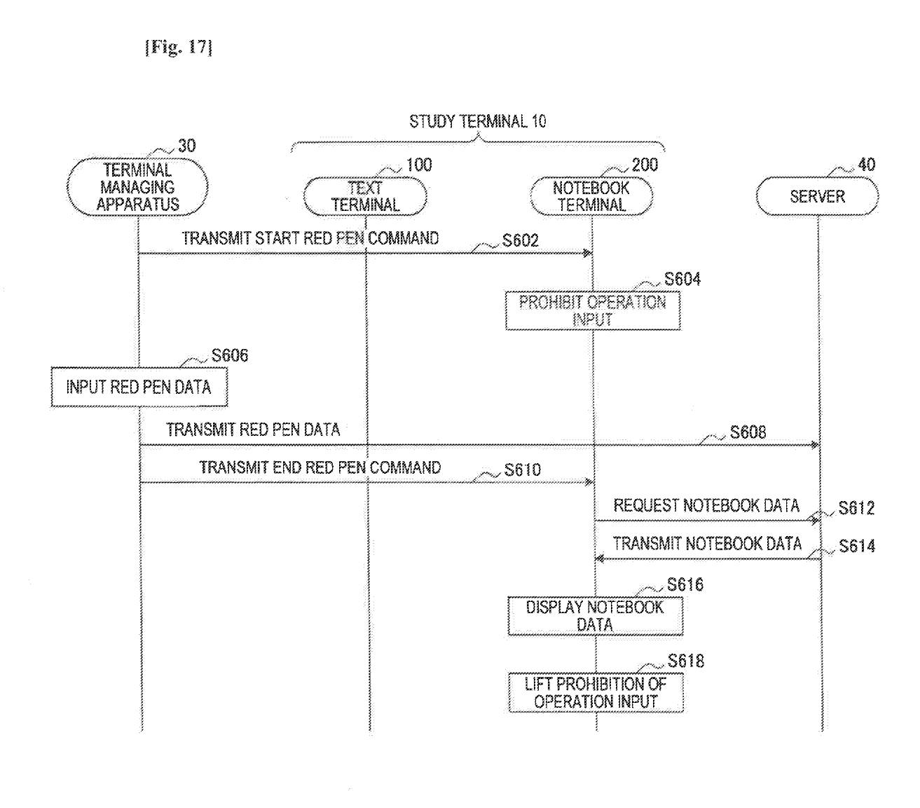

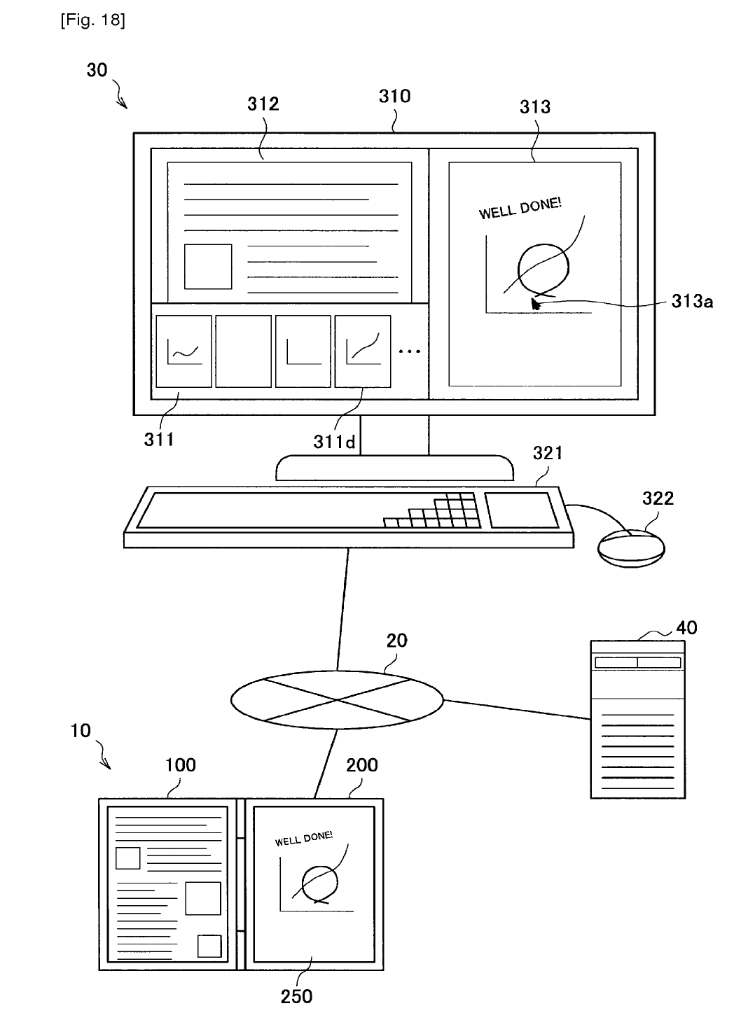

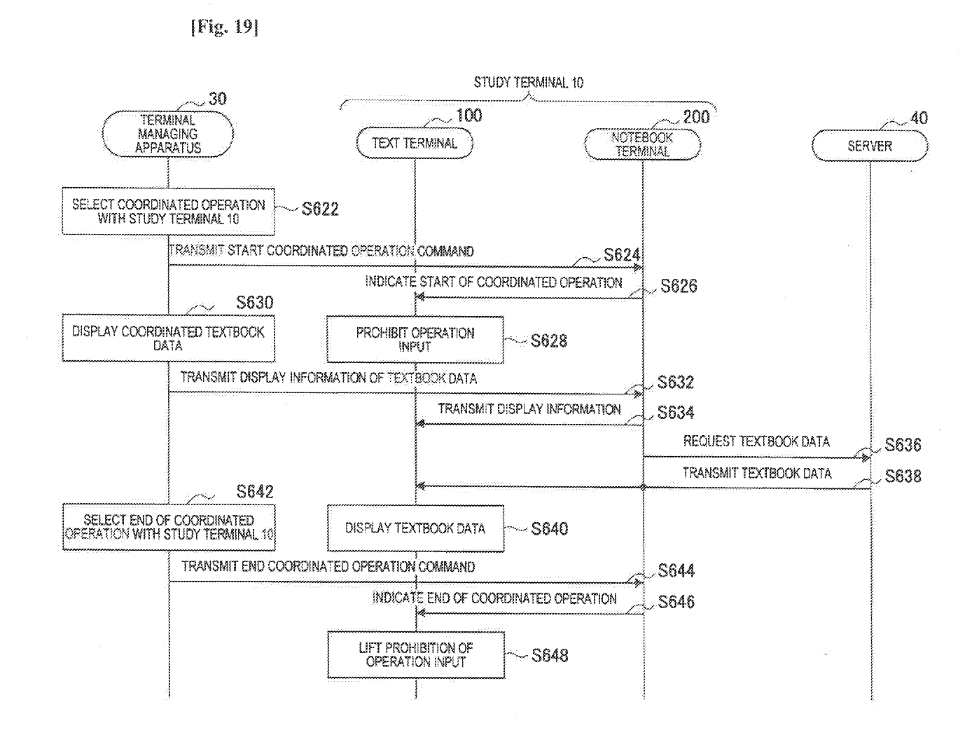

Next, a correction process according to a fifth embodiment will be described with reference to FIGS. 17 and 18.

As shown in FIG. 17, first, a start red pen command (i.e., a prohibition command) is transmitted from the terminal managing apparatus 30 to the notebook terminal 200 of the study terminal 10. Next, the notebook terminal 200 prohibits data input by the student into the notebook data region (S604).

After this, correction is carried out on the terminal managing apparatus 30 (S606). For example, as shown in FIG. 18, the notebook data 311 d selected from the list region 311 displayed on the display apparatus 310 of the terminal managing apparatus 30 is displayed and corrected in the display region 313. The correction input is made by inputting characters using the keyboard 321 and/or by inputting ticks and crosses using the mouse 322 that is a pointing device. In FIG. 18, the text “Well Done!” is inputted using the keyboard and a circle (indicating “correct”) is inputted by operating a cursor 313a using the mouse 322.

Next, the terminal managing apparatus 30 transmits the red pen data inputted as a correction by the terminal managing apparatus 30 to the server 40 (S608). At the server 40, the notebook data 220 is updated to notebook data including the red pen data. After this, the terminal managing apparatus 30 transmits an end red pen command to the notebook terminal 200 of the study terminal 10 (S610).

Next, the notebook terminal 200 receives the end red pen command from the terminal managing apparatus 30 and sends a request for the notebook data to the server 40 (S612). In response to the notebook data request from the notebook terminal 200, the server 40 transmits the notebook data to which the red pen data has been added to the notebook terminal 200 (S614).

After this, the notebook terminal 200 displays the notebook data received from the server 40 (S616). By doing so, as shown in FIG. 18, the correction content inputted by the teacher on the terminal managing apparatus 30 is reflected on the display screen (touch panel 250) of the notebook terminal 200 of the study terminal 10.

Next, the prohibition of operation input by the notebook terminal 200 is lifted (S618). In this way, the updating of the notebook data on the study terminal 10 side is not possible while corrections are being made by the teacher on the terminal managing apparatus 30.

According to the fifth embodiment described above, by having the teacher correct the notebooks of the respective students at the terminal managing apparatus 30, the corrected content is automatically reflected in the study terminals 10 of students, which means that study can proceed more efficiently.

7. Sixth Embodiment

### Coordinated Operation Process

Next, a coordinated operation process according to the sixth embodiment will be described with reference to FIG. 19. As shown in FIG. 19, first, coordinated operation with the study terminals 10 is selected at the terminal managing apparatus 30 (S622).

Next, a start coordinated operation command is transmitted from the terminal managing apparatus 30 to the notebook terminal 200 of one or more study terminals 10 (S624). After this, the notebook terminals 200 in question instruct the text terminals 100 to start coordinated operation (S626). Each text terminal 100 that has received the start coordinated operation instruction prohibits operation input by the student (S628). By doing so, it becomes no longer possible for the student to make operation inputs such as page changes of the textbook data displayed on the text terminal 100.

Meanwhile, at the terminal managing apparatus 30, textbook data subject to the coordinated operation is displayed in a text region 312. Next, the terminal managing apparatus 30 transmits display information (textbook name, page number, and the like) showing the textbook data displayed in the text region 312 to the notebook terminals 200 of the study terminals 10 in question (S632).

After this, each notebook terminal 200 transmits display information to the text terminal 100 (S634). The notebook terminals 200 also send a request for textbook data corresponding to the textbook name and page number included in the display information to the server 40 (S636). Next, in response to the requests from the notebook terminals 200, the server 40 transmits the textbook data in question via the notebook terminals 200 to the text terminals 100 (S638).

Next, at each text terminal 100, the textbook data transmitted from the server 40 is displayed on the touch panel 150 (S640). By doing so, it is possible to coordinate the display of the text region 312 of the terminal managing apparatus 30 and the display of the text terminals 100 of the study terminals 10. Note that when information showing a display position and/or enlargement is included in the display information transmitted from the notebook terminal 200 in 5634 described above, the text terminal 100 displays the received textbook data in accordance with such information.

To end the coordinated operation, the teacher selects end of coordinated operation on terminal managing apparatus 30 (S642) and the terminal managing apparatus 30 transmits an end coordinated operation command to the notebook terminals 200 in question (S644). After this, the text terminals 100 are instructed from the notebook terminals 200 to end the coordinated operation (S646). Each text terminal 100 that has received the end coordinated operation instruction then lifts the prohibition of operation input (S648).

According to the sixth embodiment described above, it is possible to coordinate the textbook data displayed on the text terminals 100 of the study terminals 10 of the respective students and the textbook data displayed in the text region 312 of the terminal managing apparatus 30 operated by the teacher. By doing so, it is possible to have textbook data that the teacher wishes to show to the students forcibly displayed on the study terminals 10, which means that study can proceed more efficiently.

### 8. Seventh Embodiment

### Distribution Process for Material Data

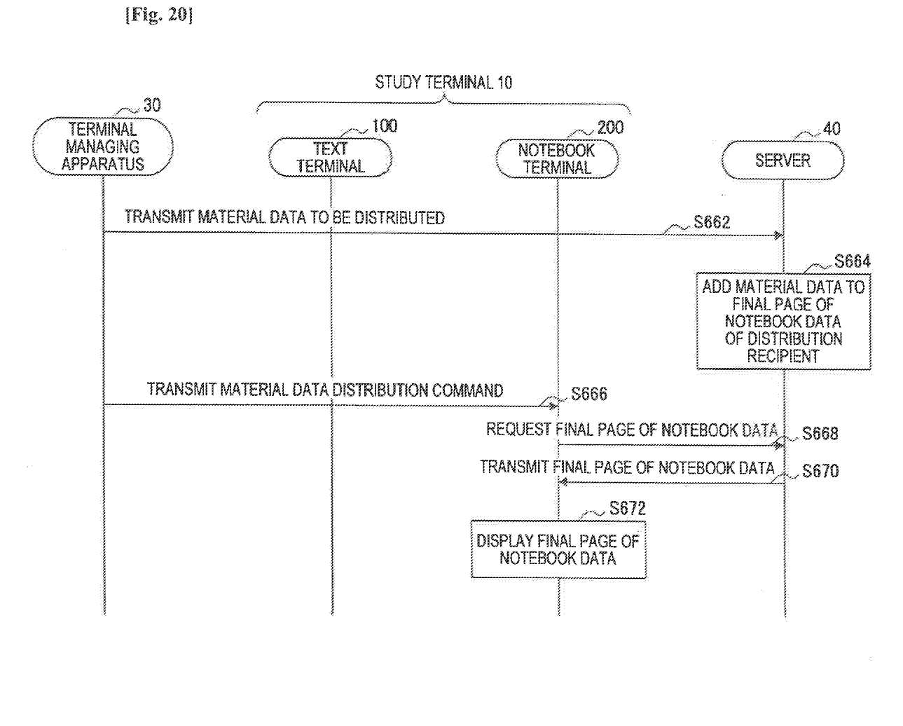

Next, a distribution process for material data according to a seventh embodiment will be described with reference to FIG. 20. As shown in FIG. 20, first, the terminal managing apparatus 30 transmits material data to be distributed to the study terminals 10 to the server 40 (S662). After this, the server 40 adds the material data to the final page of the notebook data 220 of the distribution recipients of the material data (S664). Here, the distribution recipients of the material data may be designated when the terminal managing apparatus 30 transmits the material data to the server 40.

Meanwhile, the terminal managing apparatus 30 transmits a distribute material data command to the notebook terminal 200 of the study terminal 10 of each distribution recipient (S666). Next, the notebook terminal 200 sends a request for the final page of the notebook data to the server 40 (S668). After this, in response to the request from the notebook terminal 200, the server 40 transmits the final page of the notebook data (S670).

Next, the notebook terminal 200 display's the final page of the notebook data transmitted from the server 40 on the touch panel 250 (S672). By doing so, the material data distributed from the terminal managing apparatus 30 is automatically displayed on the study terminals 10 of the distribution recipients.

According to the seventh embodiment described above, by storing material be distributed during a lesson in the server 40 as material data from the terminal managing apparatus 30 and transmitting a command to the study terminals 10 of the distribution recipients, it is possible to have the material data displayed on the respective study terminals 10, which means that study can proceed more efficiently.

### 9. Eighth Embodiment

### Groupwork

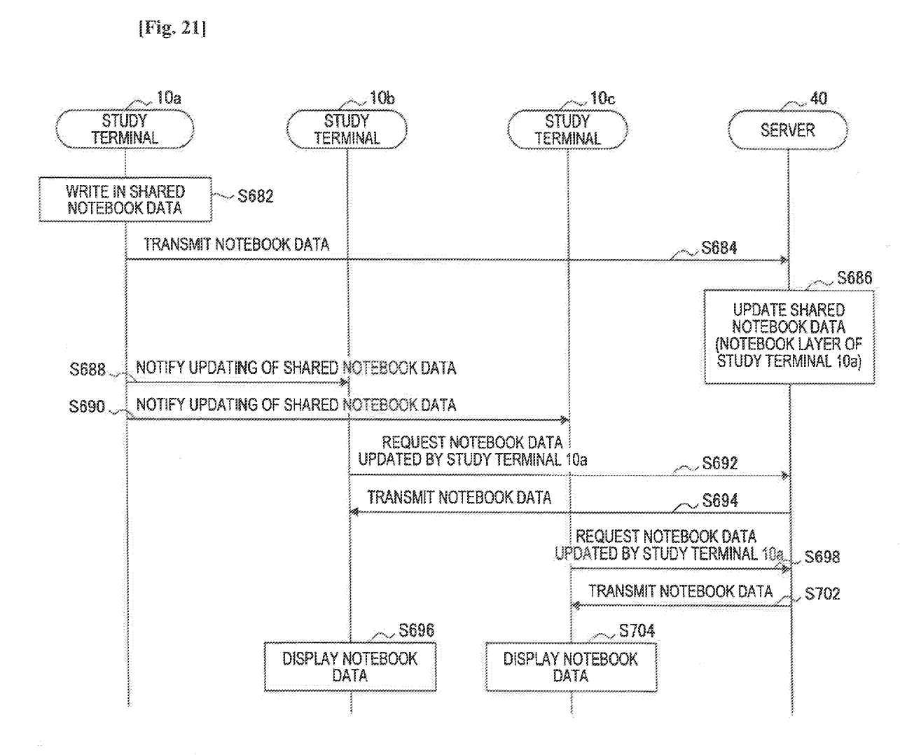

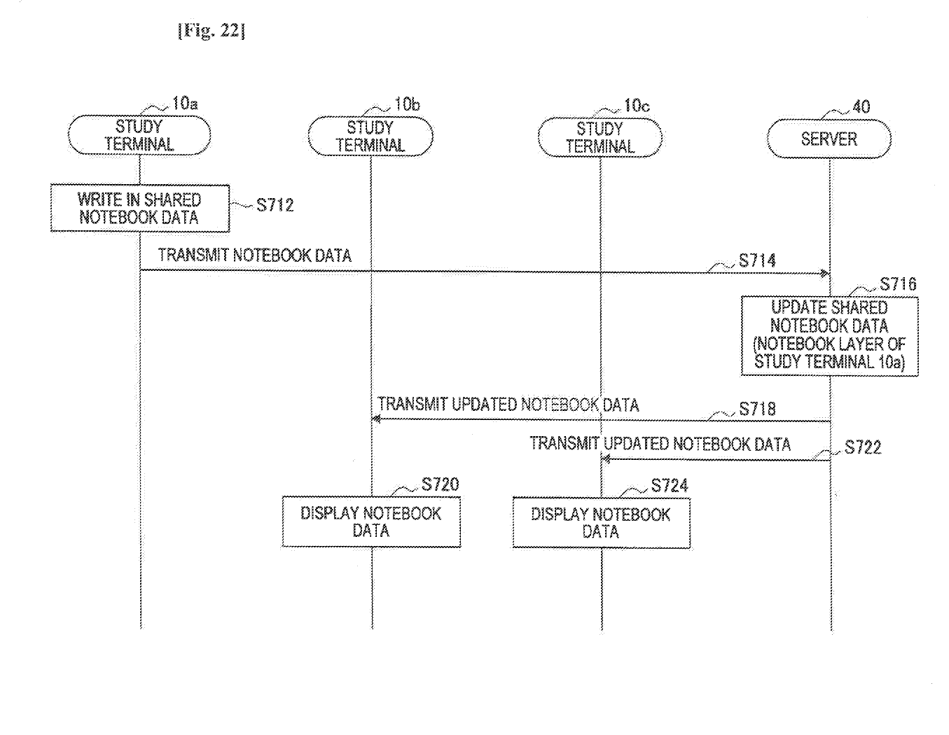

Next, groupwork according to an eighth embodiment will now be described with reference to FIGS. 21 and 22. In the present embodiment, unlike the notebook data 220 for each student used in each of the embodiments described above, shared notebook data that is shared and allows data input by a plurality of students is used.

As shown in FIG. 21, first, writing into the shared notebook data is carried, out at the study terminal 10a (S682). After this, the notebook data subjected to the write is transmitted from the study terminal 10a to the server 40 (S684). Next, the server 40 updates the shared notebook data (not shown) (S686). Here, the shared notebook data is composed of a notebook layer for each owner who shares the data, with an access restriction being set for each layer so that only the owner is able to input data. In the present embodiment, since data input has been carried out by the study terminal 10a, at the server 40, the notebook layer of the study terminal 10a is updated.

Next, the study terminal 10a notifies the other study terminals 10 (the study terminals 10b, 10c) of the updating of the shared notebook data (S688, S690). Here, the study terminals 10 that are notified of the updating may be the owners of the notebook data or may be selected arbitrarily by the study terminal 10a. The respective study terminals 10 that have been notified of the updating of the shared notebook data send a request for the notebook data updated by the study terminal 10a to the server 40 (S692, S698). In response, the server 40 transmits all of the updated shared notebook data or only the updated pages to the study terminals 10 (the study terminals 10b, 10c) (S694, S702).

After this, the respective study terminals 10 (the study terminals 10b, 10c) display the notebook data received from the server 40 on the text terminals 100 (S696, S704).

Note that the process when the shared notebook data has been updated is not limited to the example shown in FIG. 21. As one example, as shown in FIG. 22, by transmitting from the server 40 to the respective study terminals 10 when the shared notebook data has been updated, it is possible to make the process that gives notification of the updating unnecessary.

In more detail, as shown in FIG. 22, writing into the shared notebook data is carried out at the study terminal 10a (S712). After this, the notebook data that has been subjected to the write is transmitted from the study terminal 10a to the server 40 (S714). Next, the server 40 updates the shared notebook data (not shown) (S716).

After this, the server 40 transmits all of the updated shared notebook data or only the updated pages to the study terminals 10 (the study terminals 10b, 10c) (S718, S722).

Next, the respective study terminals 10 (the study terminals 10b, 10c) display the notebook data received from the server 40 on their text terminals 100 (S720, S724).

According to the eighth embodiment described above, by providing shared notebook data that is shared by only a plurality of students, study in groups can proceed more efficiently.

### 10. Ninth Embodiment

### Operation Process at Lesson End

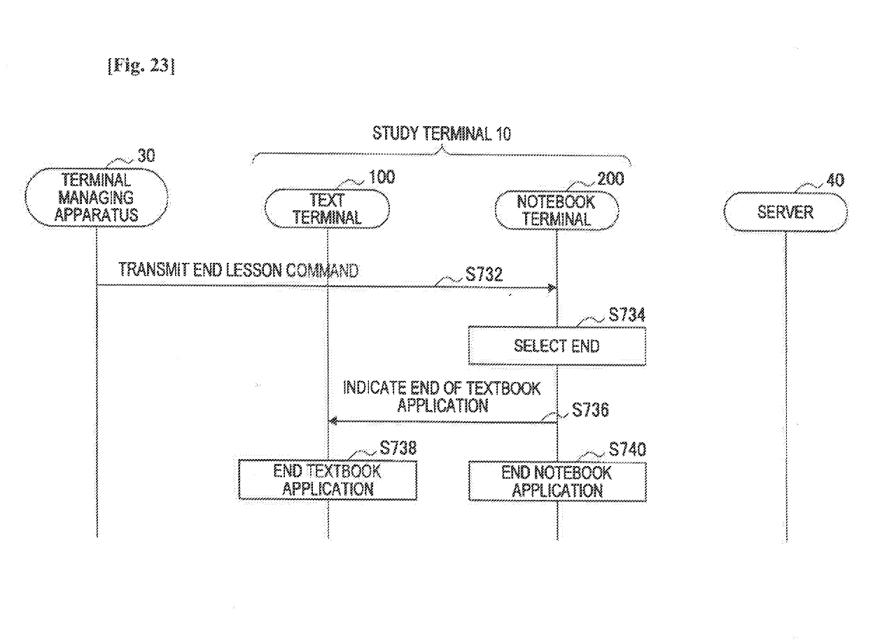

Next, an operation process when ending a lesson according to a ninth embodiment will be described with reference to FIG. 23. As shown in FIG. 23, first, an end lesson command is transmitted from the terminal managing apparatus 30 to the notebook terminal 200 of each study terminal 10 (S732). After this, the notebook terminal 200 that has received the end lesson command carries out a display that allows the student to choose whether to stop studying. When the student has selected to end the lesson (S734), the notebook terminal 200 next instructs the text terminal 100 to end the textbook application (S736). After this, the text terminal 100 ends the textbook application. The notebook terminal 200 also ends the notebook application (S740).

According to the ninth embodiment described above, by transmitting a lesson end command from the terminal managing apparatus 30 operated by the teacher to the respective study terminals 10, it is possible to end the textbook application and notebook application that are running at the text terminal 100. Also, since the decision to end the lesson at each study terminal 10 is made as described above by the students themselves, it is possible for students who wish to continue studying after the end of a lesson to continue using the study terminals 10.

### 11. Conclusion

Although preferred embodiments of the present disclosure have been described in detail above with reference to the attached drawings, the present disclosure is not limited to such examples. It should be understood by those skilled in the art that various modifications, combinations, sub-combinations and alterations may occur depending on design requirements and other factors insofar as they are within the scope of the appended claims or the equivalents thereof.

For example the study terminal 10 in the present specification is not limited to the configuration shown in FIGS. 2 and 3. For example, the study terminal may have a display screen that is divided into a teaching material region displaying the teaching material data 120 and a notebook region displaying the notebook data 220.

Also, the respective steps in the processing by the study system in the present specification do not need to be carried out in a time series in the order given in the flowcharts. As one example, the respective steps in the process at the start of a lesson shown in FIG. 10 may be carried out in a different order to the order given in the flowchart or may be carried out in parallel. In more detail, the process (S512) at the launching of the notebook application may be carried out before the instruction to launch the textbook application (S508) or may be carried out in parallel. In addition, the sending of the request to the server 40 (S514) may be carried out in parallel with S508 and/or S512.

### REFERENCE SIGNS LIST

10 study terminal
20 network
30 terminal managing apparatus
40 server
41 terminal managing apparatus database
42 student terminal database
43 teaching material database
50 access point
100 text terminal
101, 201, 301 CPU
102, 202, 302 ROM
103, 203, 303 RAM
108, 204, 208, 304 communication interface
105, 205, 305 display control portion
107, 207, 320 operation input portion
150, 250 touch panel
109, 209, 307 host bus
200 notebook terminal
220 notebook data
310 display apparatus
311 list region
312 text region
313 display region
410 student roll
420, 421, 422 link information
430 textbook data

1. A study system comprising:
a terminal managing apparatus configured to transmit a display command indicating teaching material data to be displayed on a plurality of study terminal apparatuses; and
the plurality of study terminal apparatuses each having a teaching material region displaying the teaching material data indicated by the display command and a note region capable of inputting data and displaying data;
wherein data in a region selected by a student out of the teaching material data displayed in the teaching material region is displayed in the note region in accordance with an operation by the student.

2. The study system according to claim 1,
wherein each study terminal apparatus out of the plurality of study terminal apparatuses is operable when a start lesson command including the display command has been received from the terminal managing apparatus, to display, in the note region, note data related to the teaching material data displayed in the teaching material region.

3. The study system according to claim 1,
wherein each study terminal apparatus is operable when a calling of note data has been selected, to display note data related to the teaching material data displayed in the teaching material region, and is operable when a calling of teaching material data has been selected, to display teaching material data related to the note data displayed in the note region.

4. The study system according to claim 1,
wherein the note data displayed in the note region of the study terminal apparatuses is divided into a plurality of layers.

5. The study system according to claim 4,
wherein the plurality of layers include a ruled-line layer composed of ruled-line data for which data editing from both the study terminal apparatuses and the terminal managing apparatus is not possible and one of a note layer composed of student input data for which data editing is possible from the study terminal apparatuses only and a correction layer composed of teacher input data for which data editing is possible from the terminal managing apparatus only.

6. The study system according to claim 4,
wherein each study terminal apparatus displays a layer selected by a student out of e plurality of layers.

7. The study system according to claim 2,
wherein the terminal managing apparatus has a display region displaying the note data displayed in the note region of one or more of the study terminal apparatuses.

8. The study system according to claim 5,
wherein each study terminal apparatus is operable when a start correction command has been received from the terminal managing apparatus, to prohibit data input to the note data and to display data inputted from the terminal managing apparatus as the correction layer of the note data.

9. The study system according to claim 2,
wherein each study terminal apparatus is operable when a start coordinated operation command has been received from the terminal managing apparatus, to prohibit operations to the teaching material region and to display, in the teaching material region, teaching material data being displayed at the terminal managing apparatus.

10. The study system according to claim 7,
wherein each study terminal apparatus is operable when a material data distribution command has been received from the terminal managing apparatus, to display material data indicated by the material data distribution command in the note region.

11. The study system according to claim 1,
wherein the note data displayed in the note regions of the study terminal apparatuses is shared note data including a note layer that receives data inputs only from study terminal apparatuses that specified students have logged into.

12. The study system according to claim 2,
wherein each study terminal apparatus is operable when an end lesson command has been received from the terminal managing apparatus, to carry out a display that has a student select whether to end an application that has been launched on the study terminal apparatus and end the application if the student has selected to end the application.

13. The study system according to claim 1,
wherein the study terminal apparatus includes a first touch panel acquiring position information of a first operation body and a second touch panel acquiring position information of a second operation body,
the first touch panel displays the teaching material data, and
the second touch panel displays the note data.

14. The study system according to claim 1,
wherein each study terminal apparatus is composed of a first housing having the teaching material region and a second housing having the note region.

15. The study system according to claim 14,
wherein the first housing and the second housing are detachably linked and transmit and receive data between one another.

16. The study system according to claim 1,
further comprising a server configured to connect to the terminal managing apparatus and the study terminal apparatuses,
wherein the server stores the teaching material data and the note data of each student in association with one another.

17. The study system according to claim 16,
wherein each study terminal apparatus acquires the teaching material data indicated by the display command from the server.

18. The study system according to claim 16,
wherein each study terminal apparatus acquires the note data associated with the teaching material data from the server.

19. A display method comprising:
transmitting, from a terminal managing apparatus, a display command indicating teaching material data to be displayed on a plurality of study terminal apparatuses; and
displaying the teaching material data indicated by the display command in a teaching material region of each study terminal apparatus out of a plurality of study terminal apparatuses, each of which has the teaching material region displaying the teaching material data and a note region capable of inputting data and displaying data;
wherein data in a region selected by a student out of the teaching material data displayed in the teaching material region is displayed in the note region in accordance with an operation by the student.
